(19) United States
(12) Patent Application Publication
(10) Pub. No.: US 2025/0149930 A1
(43) Pub. Date: May 8, 2025

(54) MOTOR CORE MANUFACTURING METHOD, POWER GENERATOR MANUFACTURING METHOD, MOTOR CORE, AND POWER GENERATOR

(71) Applicant: SINTOKOGIO, LTD., Nagoya-shi, Aichi (JP)

(72) Inventors: Yuta SAITO, Nagoya-shi, Aichi (JP); Yuji KOBAYASHI, Nagoya-shi, Aichi (JP)

(73) Assignee: SINTOKOGIO, LTD., Nagoya-shi, Aichi (JP)

(21) Appl. No.: 18/836,997

(22) PCT Filed: Feb. 6, 2023
(86) PCT No.: PCT/JP2023/003871

§ 371 Date: Aug. 8, 2024

(30) Foreign Application Priority Data
Feb. 15, 2022 (JP) 2022-021355
Feb. 15, 2022 (JP) 2022-021358

(51) Int. Cl. H02K 1/04; H02K 15/027

(52) U.S. Cl. CPC H02K 1/04; H02K 15/027

(57) ABSTRACT

A method of manufacturing a motor core includes preparing a plurality of electromagnetic steel sheets, peening an entire surface of at least one of a first and a second main surfaces of an electromagnetic steel sheet selected from the electromagnetic steel sheets, and forming a stack using the electromagnetic steel sheets including the electromagnetic steel sheet peened.

### TECHNICAL FIELD

The present disclosure relates to a method of manufacturing a motor core, a method of manufacturing a generator, a motor core, and a generator.

### BACKGROUND ART

Patent Document 1 discloses a method of manufacturing a core (motor core) for a generator in which electromagnetic steel sheets are stacked. The method of manufacturing includes hardening only a part of the periphery of the opening of the electromagnetic steel sheet in which the permanent magnet is arranged. The area of the hardened portion is 1% to 20% of the entire surface area of the electromagnetic steel sheet. Patent Document 1 discloses that when the sum of the hardened portions exceeds 20%, the iron loss of the entire stack in which the electromagnetic steel sheets are laminated increases.

### CITATION LIST

### Patent Document

Patent Document 1: Japanese Patent Application Publication No. 2004-7943

### SUMMARY OF INVENTION

### Technical Problem

The method of manufacturing described in Patent Document 1 has room for improvement from the viewpoint of increasing the rotational speed of the motor core or from the viewpoint of increasing the amount of power generation. The present disclosure provides a motor core having excellent rotation performance and a manufacturing method thereof. In addition, the present disclosure provides a generator having excellent power generation performance and a manufacturing method thereof.

### Solution to Problem

A method for manufacturing a motor core/generator according to an aspect of the present disclosure includes the following steps.
(1) preparing a plurality of electromagnetic steel sheets
(2) peening an entire surface of at least one of a first and a second main surfaces of an electromagnetic steel sheet selected from the electromagnetic steel sheets
(3) forming a stack using the electromagnetic steel sheets including the electromagnetic steel sheet peened

According to the manufacturing method, electromagnetic steel sheets are prepared. Then, the entire surface of at least one of the first main surface and the second main surface of an electromagnetic steel sheet selected from the electromagnetic steel sheets is peened. Then, a stack is formed by using electromagnetic steel sheets including the peened electromagnetic steel sheet. This manufacturing method can manufacture a motor core having excellent rotation performance or a generator having excellent power generation performance as compared to the case of using an electromagnetic steel sheet in which the main surface of the electromagnetic steel sheet is not peened.

In one embodiment, the electromagnetic steel sheet may have an insulating layer on the first and the second main surfaces, and the peening may include forming a plastic working layer having a changed crystal orientation on a surface of the insulating layer of the main surface to be peened. This manufacturing method can manufacture a motor core/generator in which the entire surface of the insulating layer of the electromagnetic steel sheet has the plastic working layer.

In one embodiment, the plastic working layer may have a thickness of 1 μm to 50 μm. In this manufacturing method, by processing the top surface of the insulating layer of the electromagnetic steel sheet, a motor core having excellent rotation performance or a generator having excellent power generation performance can be manufactured as compared with the case of using an electromagnetic steel sheet in which the main surface of the electromagnetic steel sheet is not peened.

In one embodiment, the plastic working layer may include crystals in which a plane parallel to the surface is a (001) plane or a (011) plane, and the crystals may account for 30% to 100% of the entire surface. According to this manufacturing method, by controlling the crystal orientation of the plastic working layer, it is possible to manufacture a motor core having excellent rotation performance or a generator having excellent power generation performance as compared with the case of using an electromagnetic steel sheet in which the main surface of the electromagnetic steel sheet is not peened.

In one embodiment, the peening may include peening the first and the second main surfaces of each of the electromagnetic steel sheets. In this manufacturing method, since all of the electromagnetic steel sheets included in the stack have the plastic working layer, a motor core having more excellent rotation performance or a generator having more excellent power generation performance can be manufactured.

A motor core/generator according to another aspect of the present disclosure includes a stack of a plurality of electromagnetic steel sheets. Each of the electromagnetic steel sheets has an insulating layer on a first and a second main surfaces. An entire surface of the insulating layer of at least one of the electromagnetic steel sheets is a plastic working layer. The plastic working layer includes crystals in which a plane parallel to the surface is a (001) plane or a (011) plane, and the crystals account for 30% to 100% of the entire surface.

According to the motor core/generator, the entire surface of the insulating layer of at least one of the electromagnetic steel sheets is the plastic working layer. Since the crystal orientation of the plastic working layer is controlled, the motor core/generator has excellent rotation performance and excellent power generation performance as compared with the case where only the electromagnetic steel sheet having no plastic working layer is provided on the entire main surface.

In one embodiment, the plastic working layer may have a thickness of 1 μm to 50 μm. In the motor core/generator, the top surface of the insulating layer of the electromagnetic steel sheet is the plastic working layer, and the motor core/generator has excellent rotation performance and excellent power generation performance as compared with the case where only the electromagnetic steel sheet having no plastic working layer is provided on the entire main surface.

### Advantageous Effects of Invention

According to the present disclosure, a generator having excellent rotation performance or excellent power generation performance and a method for manufacturing the same are provided.

### BRIEF DESCRIPTION OF DRAWINGS

FIG. 1 is a schematic diagram of a power generation system according to an embodiment.

FIG. 2 is a perspective view of a core of a generator according to an embodiment.

FIG. 3 is a plan view showing an example of the electromagnetic steel sheet of FIG. 2.

FIG. 4 is a cross-sectional view showing an example of the electromagnetic steel sheet in FIG. 2.

FIG. 5 is a flowchart illustrating an example of a method of manufacturing a generator.

### DESCRIPTION OF EMBODIMENTS

Hereinafter, embodiments of the present invention will be described with reference to the drawings. In the drawings, the same or corresponding parts are denoted by the same reference numerals.

### Configuration of Power Generation System

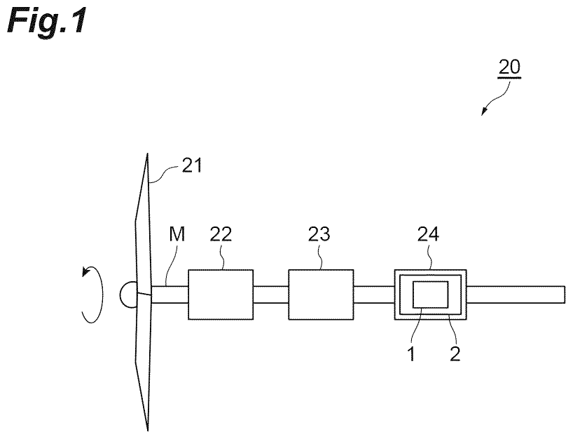

FIG. 1 is a schematic diagram of a power generation system according to an embodiment. A power generation system 20 includes a blade 21, a speed-increasing gear 22, a brake device 23, and a generator 24. The blade 21 is connected to the speed-increasing gear 22, the brake device 23, and the generator 24 via a power transmission shaft M. The blade 21 rotates by water, wind, vapor (heated air), and the like. The speed- increasing gear 22 amplifies the rotation speed of the power transmission shaft M. The brake device 23 reduces the rotation speed of the power transmission shaft M. The speed-increasing gear 22 and the brake device 23 control the rotation of the power transmission shaft M. The generator 24 converts the kinetic energy of the power transmission shaft M into electrical energy. The generator 24 includes a core 1 (an example of a motor core) and a stator 2, and generates electric power by a counter-electromotive force.

### Configuration of Core of Generator

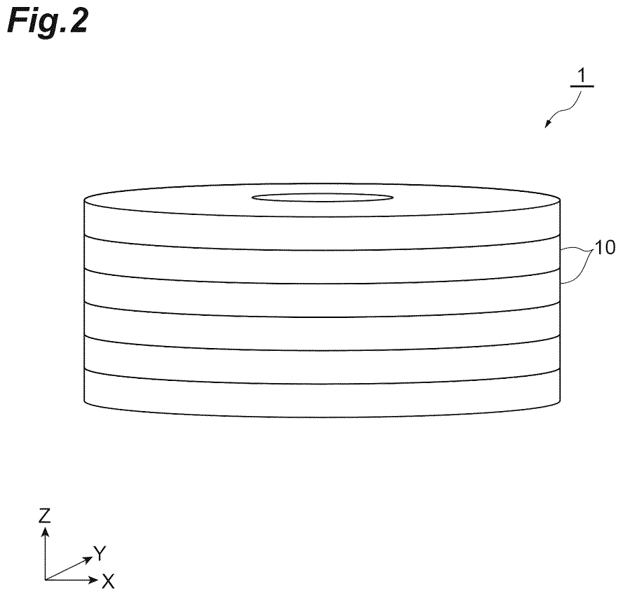

FIG. 2 is a perspective view of a core of a generator according to an embodiment. As shown in FIG. 2, the core 1 is a rotor core, which is a generator component rotating with respect to a stator. The core 1 has a plurality of electromagnetic steel sheets 10. The electromagnetic steel sheets 10 is pressed, fixed, or bonded to form a stack. The stack has, for example, a cylindrical shape, and a shaft hole is provided at the center of the stack.

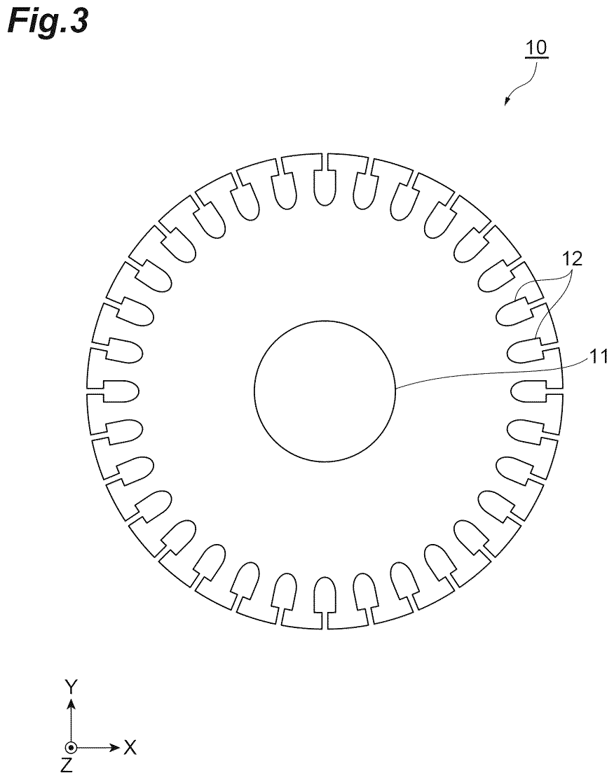

FIG. 3 is a plan view showing an example of the electromagnetic steel sheet of FIG. 2. The electromagnetic steel sheet 10 shown in FIG. 3 is a disc-shaped member formed of a soft magnetic material. The electromagnetic steel sheet 10 may be, for example, a non-oriented electrical steel sheet having magnetic properties in all directions. A shaft hole 11 is formed in the center of the electromagnetic steel sheet 10. The shaft hole 11 is a through hole in which the power transmission shaft M of the generator 24 is placed. A rotor slot 12 is formed at the outer edge of the electromagnetic steel sheet 10. The rotor slot 12 is a through hole in which the permanent magnet is arranged. The electromagnetic steel sheet 10 has a thickness of about 0.3 mm to 1.0 mm.

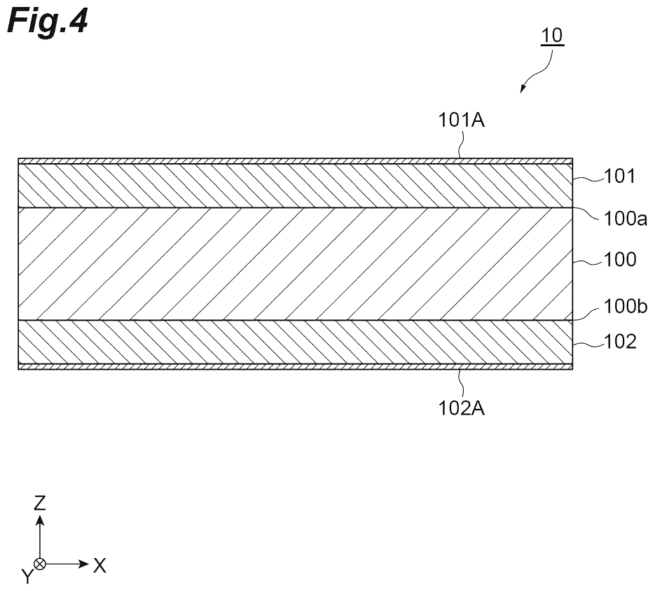

FIG. 4 is a cross-sectional view showing an example of the electromagnetic steel sheet of FIG. 2. As shown in FIG. 4, the electromagnetic steel sheet 10 has a body 100 formed of a soft magnetic material. The main body 100 has a first main surface 100a and a second main surface 100b. On the first main surface 100a, a first insulating layer 101 is formed to suppress the generation of eddy currents. Similarly, the second insulating layer 102 is formed on the second insulating main surface 100b in order to suppress generation of eddy currents.

A first plastic working layer 101A is formed on the entire surface (full surface) of the insulating layer 101. The first plastic working layer 101A is formed by plastic working of the first insulating layer 101. An example of the plastic working is peening. The peening is, for example, shot peening, burnishing, or laser peening. The first plastic working layer 101A is formed by changing the crystalline orientation of the first insulating layer 101. In the first plastic working layer 101A, crystals whose planes parallel to the surfaces are (001) planes or (011) planes account for 30% to 100% of the entire surfaces. In the first plastic working layer 101A, crystals whose planes parallel to the surfaces are (001) planes or (011) planes may account for 30% to 60% of the entire surfaces. The first plastic working layer 101A may be 1 μm to 50 μm thick. Similarly to the first insulating layer 101, the second plastic working layer 102A is formed on the entire surface (full surface) of the second insulating layer 102. The second plastic working layer 102A is formed by plastic working of the second insulating layer 102. The forming method, dimensions, shape and the like of the second plastic working layer 102A are identical to those of the first plastic working layer 101A.

### Modified Example of Generator

The core 1 is not limited to a rotor core, and may be a stator core. The core 1 may be employed as a rotor of a motor. The electromagnetic steel sheet 10 may include only one of the first insulating layer 101 and the second insulating layer 102. The electromagnetic steel sheet 10 may not include the first insulating layer 101 and the second insulating layer 102. Only at least one of the electromagnetic steel sheets 10 may have a plastic working layer.

### Manufacturing Method of Generator

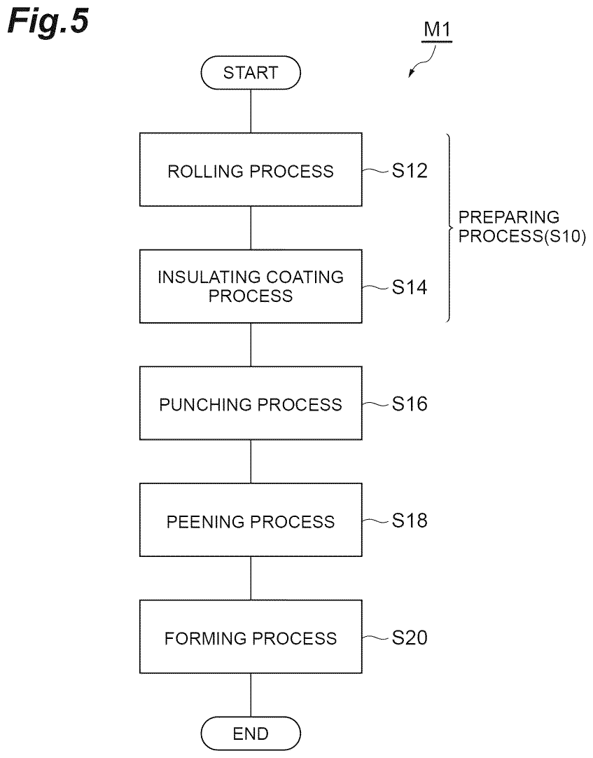

FIG. 5 is a flowchart illustrating an example of a method of manufacturing a generator. In a manufacturing method M1, first, a preparing process (S10) is performed. In the preparing process (S10), a plurality of electromagnetic steel sheets 10 is prepared. In detail, the preparing process S10 may include a rolling process S12 and an insulating coating process S14.

In the rolling process (S12), the raw materials are rolled into a thin plate (main body 100 in FIG. 4) by a roller or the like. The rolling may be hot rolling or cold rolling. In addition, processes such as annealing may be appropriately combined. When the rolling process (S12) is completed, an insulating coating process (S14) is performed.

In the insulating coating process (S14), insulating layers (the first insulating layer 101 and the second insulating layer 102 in FIG. 4) are formed on the entire main surfaces of the board. For example, an insulating coating liquid is applied to the main surfaces of the plate by a rotor or the like. The insulating layers are formed by solidifying the insulating coating liquid. When the preparing process (S10) is finished, the punching process (S16) is executed.

In the punching process (S16), the shaft hole 11 and the rotor slot 12 shown in FIG. 3 are formed by punching, for example, by a punching device. When the punching process (S16) is finished, a peening process (S18) is executed.

In the peening process (S18), the surfaces of the insulating layers are peened, and plastic working layers are formed on the surfaces of the insulating layers (first plastic working layer 101A and second plastic working layer 102A in FIG. 4). In the peening process, for example, shot peening, burnishing, or laser peening is used. The peening is performed such that crystals in which a plane parallel to the surface is a (001) plane or a (011) plane account for 30% to 100% of the entire surface. The peening is performed such that the thickness of the plastic working layer is 1 μm to 50 μm. When the peening process (S18) is finished, the forming process (S20) is executed.

In the forming process (S20), electromagnetic steel sheets 10 is pressed, fixed, or bonded to form a stack. The electromagnetic steel sheets 10 are formed through the above processes. After the forming process (S20), the core 1 and the stator 2 are assembled to complete the generator.

### Modified Example of Manufacturing Method of Generator

The peening process (S18) may be performed between the insulating coating process (S14) and the punching process (S16). In the peening process (S18), the entire surface of the first insulating layer 101 and the second insulating layer 102 of each of the electromagnetic steel sheets 10 may be peened. Alternatively, the entire surface of the first insulating layer 101 and the second insulating layer 102 made of the electromagnetic steel sheet 10 selected from the electromagnetic steel sheets 10 may be peened. The core 1 manufactured by the manufacturing method M1 is not limited to a rotor core, and may be a stator core. The core 1 manufactured by the manufacturing method M1 may be employed as a rotor of a motor.

While exemplary embodiments have been described above, various omissions, substitutions, and changes may be made without being limited to the exemplary embodiments described above.

### EXAMPLE

Hereinafter, Examples and Comparative Examples performed by the present inventors will be described in order to explain the effect of the generator.

### Example 1

Both surfaces of each of the electromagnetic steel sheets 10 were subjected to shot peening, and then they were stacked. Shot peening was performed using glass beads as media at an injection pressure of 0.2[MPa], injection amount 1.96 [kg/min].

### Example 2

Both surfaces of each of the electromagnetic steel sheets 10 were burnished, and then they were stacked. The burnishing was performed by applying a pressing force with a carbide tool at a sliding speed of 13,500 rpm., cross feed 50 [μm], injection amount 1.96 [kg/min].

### Example 3

Only one surface of each of the electromagnetic steel sheets 10 was subjected to shot peening, and then they were stacked. The conditions for shot peening were the same as in Example 1.

### Example 4

Only one surface of each of the electromagnetic steel sheets 10 was subjected to shot peening, and then they were stacked. Shot peening was performed using steel shots as media at an injection pressure of 0.3[MPa], injection amount 1.96 [kg/min]. The thickness of the plastic working layer was 50 to 100 [μm].

### Example 5

Only one surface of each of the electromagnetic steel sheets 10 was subjected to shot peening, and then they were stacked. The conditions for shot peening were the same as in Example 1. This example is the same as Example 3 except that the thickness of the plastic working layer was measured. The thickness of the plastic working layer was 10 to 30 [μm].

### Example 6

Only one surface of each of the electromagnetic steel sheets 10 was subjected to shot peening, and then they were stacked. During shot peening, a region other than the rotor slot was masked. This example is the same as Example 3 except that the thickness of the plastic working layer was measured. The thickness of the plastic working layer was 5 to 20 [μm].

### Comparative Example

The untreated electromagnetic steel sheets 10 were stacked.

### Confirmation of Effect of Increased Power Generation

The stack was used as a core, and the power generation amount was measured by an ammeter and a voltmeter while controlling the number of rotations. It was confirmed that the power generation amount was improved in Examples 1 and 2 as compared with Comparative Example. As described above, it was confirmed that the power generation amount was improved by peening the electromagnetic steel sheets 10.

### Confirmation of Effect of Rotation Speed Increase

The stack was used as a motor core, and the number of rotations was checked with a non-contact tachometer while controlling the voltage and current.
Example 1: Voltage 3.4 [V], current 5.3 [A], rotation speed 15000 [rpm]
Example 2: Voltage 3.2 [V], current 5.2 [A], rotation speed 11900 [rpm]
Example 3: Voltage 1.8 [V], current 5.1 [A], rotation speed 11200 [rpm]
Comparative Example: Voltage 3.2 [V], current 5.3 [A], rotation speed 10100 [rpm]

As described above, it was confirmed that the number of rotations was improved by about 1.5 times in Example 1 as compared with Comparative Example. In addition, it was confirmed that the number of rotations was improved by about 1.2 times in Example 2 as compared with Comparative Example. As described above, it was confirmed that the rotational speed was improved by peening the electromagnetic steel sheets 10. In Example 3 in which only one surface of each of the electromagnetic steel sheets 10 was peened, it was confirmed that the number of rotations was increased as compared with Comparative Example. That is, it was confirmed that even when only one surface of each of the electromagnetic steel sheets 10 was peened, the effect of increasing the number of rotations was obtained.

### Relationship Between Thickness of Plastic Working Layer and Number of Rotations

The thickness of the plastic working layer decreases in the order of Examples 4, 5, and 6. In Examples 4, 5, and 6, the stack was used as a motor core, and the number of rotations was checked with a non-contact tachometer while controlling the voltage and current.
Example 4: Voltage 3.1 [V], current 5.3 [A], rotation speed 9900 [rpm]
Example 5: Voltage 3.1 [V], current 5.3 [A], rotation speed 10200 [rpm]
Example 6: Voltage 3.4 [V], current 5.3 [A], rotation speed 12000 [rpm]

Thus, it was confirmed that the number of rotations increases as the thickness of the plastic working layer decreases. The number of rotations in Example 4 is smaller than that in Comparative Example, and the number of rotations in Examples 5 and 6 is larger than that in Comparative Example. Therefore, it was confirmed that a motor core having excellent rotation performance can be produced by processing the extreme surface (having a thickness of about 1 μm to 50 μm) of the plastic working layer.

### REFERENCE SIGNS LIST

1 . . . core, 10 . . . electromagnetic steel sheets, 101 . . . first insulating layer, 101A . . . first plastic working layer, 102 . . . second insulating layer, 102A . . . second plastic working layer, 24 . . . generator.

1. A method of manufacturing a motor core comprising:
preparing a plurality of electromagnetic steel sheets;
peening an entire surface of at least one of a first and a second main surfaces of an electromagnetic steel sheet selected from the electromagnetic steel sheets; and
forming a stack using the electromagnetic steel sheets including the electromagnetic steel sheet peened.

2. The method according to claim 1, wherein the electromagnetic steel sheet has an insulating layer on the first and the second main surfaces, and the peening includes forming a plastic working layer having a changed crystal orientation on a surface of the insulating layer of the main surface to be peened.

3. The method according to claim 2, wherein the plastic working layer has a thickness of 1 μm to 50 μm.

4. The method according to claim 2, wherein the plastic working layer includes crystals in which a plane parallel to the surface is a (001) plane or a (011) plane, and the crystals account for 30% to 100% of the entire surface.

5. The method according to claim 1, wherein the peening includes peening the first and the second main surfaces of each of the electromagnetic steel sheets.

6. A method for manufacturing a generator including the motor core manufactured by the method according to claim 1.

7. A motor core comprising a stack of a plurality of electromagnetic steel sheets, wherein
each of the electromagnetic steel sheets has an insulating layer on a first and a second main surface, and
an entire surface of the insulating layer of at least one of the electromagnetic steel sheets is a plastic working layer, and
the plastic working layer includes crystals in which a plane parallel to the surface is a (001) plane or a (011) plane, and the crystals account for 30% to 100% of the entire surface.

8. The motor core according to claim 7, wherein the plastic working layer has a thickness of 1 μm to 50 μm.

9. A generator comprising the motor core according to claim 7.
